(19) United States
(12) Patent Application Publication
(10) Pub. No.: US 2026/0268564 A1
(43) Pub. Date: Sep. 10, 2026

(54) IMAGE-BASED ANIMATION GENERATION METHOD AND APPARATUS, DEVICE, AND STORAGE MEDIUM

(71) Applicant: Beijing Zitiao Network Technology Co., Ltd., Beijing (CN)

(72) Inventor: Yunhao LIAO, Beijing (CN)

(21) Appl. No.: 18/876,192

(22) PCT Filed: Aug. 4, 2023
(86) PCT No.: PCT/CN2023/111187

§ 371 Date: Dec. 18, 2024

(30) Foreign Application Priority Data
Aug. 5, 2022 (CN) 202210939720.9

(51) Int. Cl. G06T 13/20; G06T 3/60; G06T 7/13; G06T 7/246; G06T 7/73

(52) U.S. Cl. CPC G06T 13/20; G06T 3/60; G06T 7/13; G06T 7/246; G06T 7/73; G06T 2210/12; G06T 2210/62

(57) ABSTRACT

Embodiments of the present disclosure provide an image-based animation generation method and apparatus, a device, and a storage medium. The method comprises: determining a starting point and a termination point of a target image in a set coordinate system; determining a motion vector of the target image based on the starting point and the termination point, wherein the motion vector is a direction vector pointing from the starting point to the termination point; determining a motion curve of the target image based on the motion vector, wherein the motion curve comprises a transverse motion curve and a longitudinal motion curve; and controlling the target image to move from the starting point to the termination point according to the motion curve to generate a motion animation of the target image.

### CROSS-REFERENCE TO RELATED APPLICATION(S)

The present disclosure claims priority to Chinese Patent Application No. 202210939720.9, filed with the China National Intellectual Property Administration on Aug. 5, 2022, the disclosure of which is incorporated herein by reference in its entirety.

### FIELD

Embodiments of the present disclosure relates to the technical field of image processing, and for example, to an image-based animation generation method and apparatus, a device, and a storage medium.

### BACKGROUND

At present, generation of a motion animation of images between two points is generally achieved in a screen space. However, it is difficult for motions in the screen space to cooperate with camera movement effects such as lens zooming, focal length changing, lens displacement, lens rotation, and parallax disturbance. Moreover, if a motion animation implemented in the screen space is integrated into a complex 3D scene, the animation effect will not be fluent, and the display effect will be poor.

### SUMMARY

The embodiments of the present disclosure provide an image-based animation generation method and apparatus, a device, and a storage medium, which can generate a motion animation of an image, causing generated motion animations smoothly transitioned and enhancing the animation display effect.

In a first aspect, embodiments of the present disclosure provide an image-based animation generation method, including: determining a starting point and a termination point of a target image in a set coordinate system; determining a motion vector of the target image based on the starting point and the termination point, wherein the motion vector is a direction vector pointing from the starting point to the termination point; determining a motion curve of the target image based on the motion vector, wherein the motion curve includes a transverse motion curve and a longitudinal motion curve; and controlling the target image to move from the starting point to the termination point according to the motion curve to generate a motion animation of the target image.

In a second aspect, embodiments of the present disclosure further provide an image-based animation generation apparatus, including: a starting and termination points determining module, configured to determine a starting point and a termination point of a target image in a set coordinate system; a motion vector determining module, configured to determine a motion vector of the target image based on the starting point and the termination point, wherein the motion vector is a direction vector pointing from the starting point to the termination point; a motion curve determining module, configured to determine a motion curve of the target image based on the motion vector, wherein the motion curve includes a transverse motion curve and a longitudinal motion curve; and an animation generation module, configured to control the target image to move from the starting point to the termination point according to the motion curve to generate a motion animation of the target image.

In a third aspect, embodiments of the present disclosure provide an electronic device. The electronic device includes: at least one processor; and a storage apparatus configured to storage at least one program, wherein the at least one program, when executed by the at least one processor, causes the at least one processor to implement the image-based animation generation method described in embodiments of the present disclosure.

In a fourth aspect, embodiments of the present disclosure further provide a storage medium including computer-executable instructions. When executed by a computer processor, the computer-executable instructions are used for performing the image-based animation generation method described in the embodiments of the present disclosure.

### BRIEF DESCRIPTION OF THE DRAWINGS

Throughout the accompanying drawings, identical or similar reference numerals represent identical or similar elements. It should be understood that the accompanying drawings are illustrative, and components and elements may not necessarily be drawn to scale.

FIG. 1 is a flowchart of an image-based animation generation method according to embodiments of the present disclosure;

FIG. 2 is an example diagram of a motion vector according to embodiments of the present disclosure;

FIG. 3 is a schematic diagram of a bounding box of a motion vector according to embodiments of the present disclosure;

FIG. 4 is a schematic diagram of direction information of a motion vector according to embodiments of the present disclosure;

FIG. 5 is a schematic diagram of relative position information between a motion curve and a motion vector according to embodiments of the present disclosure;

FIG. 6 is a schematic diagram of determining relative position information between the motion curve and the motion vector according to embodiments of the present disclosure;

FIG. 7 is an example diagram of angle information of a motion vector according to embodiments of the present disclosure;

FIG. 8 is a schematic structural diagram of an image-based animation generation apparatus according to embodiments of the present disclosure; and

FIG. 9 is a schematic structural diagram of an electronic device provided according to embodiments of the present disclosure.

### DETAILED DESCRIPTION OF EMBODIMENTS

The embodiments of the present disclosure will be described in detail below with reference to the accompanying drawings.

It should be understood that respective steps recorded in method implementations of the present disclosure can be executed in different orders and/or in parallel. In addition, the method implementations may include additional steps and/or omit the execution of the steps shown. The scope of the present disclosure is not limited in this aspect.

The term “comprise/include” and its variants as used herein mean widespread inclusion, namely, “comprising/including but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

It should be noted that the concepts such as “first” and “second” mentioned in the present disclosure are only used to distinguish different apparatuses, modules, or units, and are not intended to limit the order or interdependence of the functions performed by these apparatuses, modules, or units.

It should be noted that the modifications of “one” and “plurality” mentioned in the present disclosure are indicative rather than restrictive, and those skilled in the art should understand that unless otherwise explicitly stated in the context, they should be understood as “at least one”.

Messages or names of information interacted between a plurality of apparatuses in the implementations of the present disclosure are only for illustrative purposes and are not intended to limit the messages or the scope of the information.

It can be understood that before use of the technical solutions disclosed in various embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to that an active request of a user has been received, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the technical solutions of the present disclosure based on the prompt information.

As an optional but non-restrictive implementation, in response to that an active request of a user has been received, prompt information is sent to the user through, for example, a pop-up window where the prompt information can be presented in text. In addition, the pop-up window can also carry a selection control for the user to select whether to “agree” or “refuse” to provide the personal information to the electronic device.

It can be understood that the above notification and the above user authorization obtaining process are only illustrative and do not constitute a limitation on the implementations of the present disclosure. Other methods that meet the relevant laws and regulations can also be applied to the implementations of the present disclosure.

It can be understood that data involved in the technical solutions (including but not limited to the data itself, and obtaining or use of the data) should comply with the requirements of corresponding laws and regulations and relevant provisions.

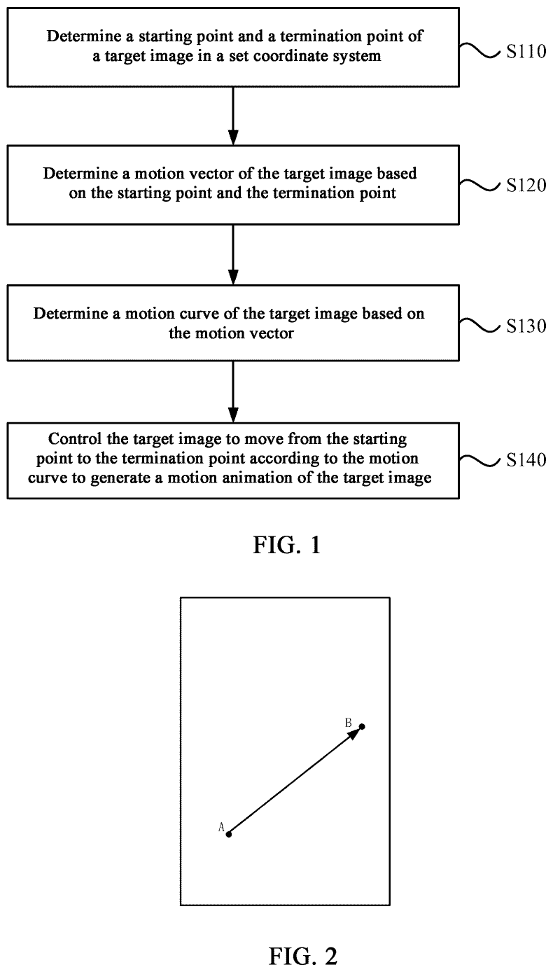

FIG. 1 is a flowchart of an image-based animation generation method according to embodiments of the present disclosure. The embodiments of the present disclosure are applicable to a situation for generating a motion animation of an image in a screen. The method can be performed by an image-based animation generation apparatus. The apparatus can be implemented in the form of software and/or hardware. Optionally, the apparatus is implemented through an electronic device. The electronic device can be a mobile terminal, a personal computer (PC) end, a server, or the like.

As shown in FIG. 1, the method includes:

S110, a starting point and a termination point of a target image in a set coordinate system are determined.

The set coordinate system may be a normalized device coordinates (NDC) system. The starting point may be a coordinate of a center point of the target image in a starting position, and the termination point may be a coordinate of the center point of the target image in a termination position.

In this embodiment, a matrix of a camera coordinate system is represented as V, and a matrix of a clip coordinate system is represented as P. A process of determining the starting point and the termination point of the target image in the set coordinate system can be as follows: First, a starting point coordinate and a termination point coordinate of the target image in a world coordinate system are obtained. Then, the starting point coordinate and the termination point coordinate are respectively leftwards multiplied by a transformation matrix VP, to obtain a starting point coordinate and a termination point coordinate in the clip coordinate system. Homogeneous transformation is executed on the starting point coordinate and the termination point coordinate in the clip coordinate system to obtain a starting point coordinate and a termination point coordinate in the NDC system.

A coordinate in the clip coordinate system is a four-dimensional coordinate, which can be represented as (x, y, z, w). The manner for executing the homogeneous transformation on the starting point coordinate and the termination point coordinate in the clip coordinate system may be: dividing x, y, and z by w to obtain the coordinates in the NDC system. In this embodiment, a range of a three-dimensional coordinate in the NDC system is [−1, 1], which means that the NDC system can be understood as a cube with a side length of 2. In this embodiment, in a process of determining subsequent motion curves, an x-coordinate and a y-coordinate are used for calculation.

In this embodiment, determining the motion curves in the NDC system can naturally fuse curve motions in an NDC space with the rendering and camera movement effects of a three-dimensional space.

S120, a motion vector of the target image is determined based on the starting point and the termination point.

The motion vector is a direction vector pointing from the starting point to the termination point, and the motion vector may be a two-dimensional vector obtained by subtracting the starting point coordinate from the termination point coordinate. Exemplarily, FIG. 2 shows an example diagram of a motion vector of this embodiment. As shown in FIG. 2, point A is the starting point and point B is the termination point. Therefore, a vector pointing from point A to point B is the motion vector of the target image.

S130, a motion curve of the target image is determined based on the motion vector.

The motion curve includes a transverse motion curve and a longitudinal motion curve. The transverse motion curve may represent a transverse motion trajectory of the target image, and the longitudinal motion curve may represent a longitudinal motion trajectory of the target image.

In this embodiment, a manner for determining the motion curve of the target image based on the motion vector may be: obtaining direction information, angle information with coordinate axes, and bounding box information of the motion vector; and determining the motion curve of the target image based on the direction information, the angle information, and the bounding box information.

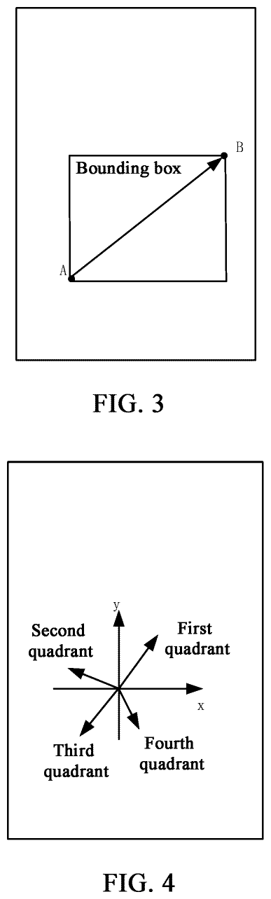

The bounding box is a rectangular bounding box with each edge being parallel to a coordinate axis. Exemplarily, FIG. 3 shows a bounding box of the motion vector in this embodiment. As shown in FIG. 3, an upper edge and a lower edge of the bounding box are parallel to a horizontal axis, and a left edge and a right edge of the bounding box are parallel to a vertical axis. The direction information includes any one of the following: the motion vector pointing to a first quadrant, the motion vector pointing to a second quadrant, the motion vector pointing to a third quadrant, or the motion vector pointing to a fourth quadrant. The angle information includes any one of the following: an angle between the motion vector and the horizontal axis being greater than a set threshold and an angle between the motion vector and the vertical axis being greater than the set threshold, or the angle between the motion vector and the horizontal axis being less than the set threshold and the angle between the motion vector and the vertical axis being less than the set threshold. The bounding box information includes size information of the bounding box and distances between edges of the bounding box and boundaries of a screen; where the size information includes a height and a width; and the edges of the bounding box include the upper edge, the lower edge, the left edge, and the right edge.

The height and width of the bounding box may be values converted through an aspect ratio. Exemplarily, assuming that a height of h and a width of w are calculated based on the starting point coordinate and the termination point coordinate in the NDC system, and assuming that the aspect ratio is a/b. After conversion, the height is h*a/b and the width is still w. Alternatively, after conversion, the height is still h and the width is w*b/a. The set threshold can be set to any value between 20 degrees to 25 degrees, for example, 22.5 degrees.

Exemplarily, a manner for obtaining the direction information of the motion vector may be: determining the direction information of the motion vector based on positive and negative characteristics of a transverse component and a longitudinal component of the motion vector. If the transverse component is positive and the longitudinal component is positive, the motion vector points to the first quadrant. If the transverse component is negative and the longitudinal component is positive, the motion vector points to the second quadrant. If the transverse component is negative and the longitudinal component is negative, the motion vector points to the third quadrant. If the transverse component is positive and the longitudinal component is negative, the motion vector points to the fourth quadrant. Exemplarily, FIG. 4 is a schematic diagram of direction information of a motion vector in this embodiment.

The angle information between the motion vector and the coordinate axes may be angles between the motion vector and forward vector (1, 0) of the horizontal axis, negative vector (−1,0) of the horizontal axis, positive vector (0,1) of the vertical axis, and negative vector (0,−1) of the vertical axis, respectively.

Exemplarily, a manner for obtaining the angle information between the motion vector and the coordinate axes may be: calculating dot product results of the motion vector by the positive vector of the horizontal axis, the negative vector of the horizontal axis, the positive vector of the vertical axis, and the negative vector of the vertical axis respectively; and determining the angle information between the motion vector and the coordinate axes based on the dot product results. In this embodiment, obtaining the direction information, the angle information with the coordinate axes, and the bounding box information of the motion vector is beneficial to improve the accuracy of subsequent motion curve determination.

Optionally, a manner for determining the motion curve of the target image based on the direction information, the angle information, and the bounding box information may be: determining relative position information between the motion curve and the motion vector based on the bounding box information; and determining the motion curve of the target image based on the direction information, the angle information, and the relative position information.

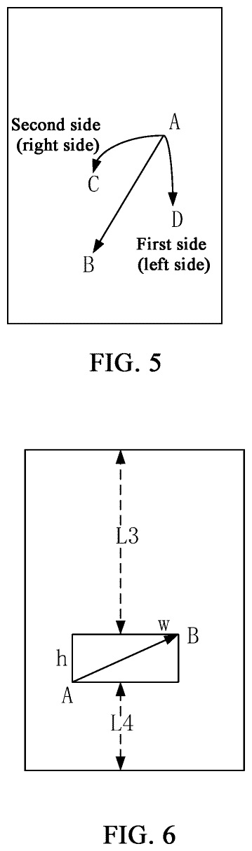

The relative position information includes the motion curve being located on a first side or a second side of the motion vector. The relative position information can be understood as being located on two sides of the motion vector based on the motion vector. The first side can be located on a left side of the motion vector, and the second side can be located on a right side of the motion vector. Exemplarily, FIG. 5 is a schematic diagram of the relative position information between the motion curve and the motion vector in this embodiment. As shown in FIG. 5, for motion vector AB, curve AD is a curve located on the first side (left side) of motion vector AB, and curve AC is a curve located on the second side (right side) of motion vector AB. In this embodiment, the motion curve of the target image is determined based on the direction information, the angle information, and the relative position information, so that the determined motion curve is located in the screen, which can prevent the impact, caused by the fact that the target image is clipped by the screen in a moving process, on the display effect.

Optionally, a manner for determining the relative position information between the motion curve and the motion vector based on the bounding box information may be: if the height of the bounding box is greater than or equal to the width, obtaining a first distance between the left edge of the bounding box and a left boundary of the screen and a second distance between the right edge of the bounding box and a right boundary of the screen; obtaining a first comparison result between the first distance and the second distance, and determining the relative position information between the motion curve and the motion vector based on the first comparison result; if the height of the bounding box is less than the width, obtaining a third distance between the upper edge of the bounding box and an upper boundary of the screen and a fourth distance between the lower edge of the bounding box and a lower boundary of the screen; and obtaining a second comparison result between the third distance and the fourth distance, and determining the relative position information between the motion curve and the motion vector based on the second comparison result.

The first comparison result may include the first distance being greater than or equal to the second distance, or the first distance being less than the second distance. The second comparison result may include the third distance being greater than or equal to the fourth distance, or the third distance being less than the fourth distance.

In this embodiment, if the height of the bounding box is greater than or equal to the width, it indicates that a longitudinal distance of motion of the target image is greater than a transverse distance. In this case, the relative position information between the motion curve and the motion vector is determined through the distances between the bounding box and vertical boundaries (including the left boundary and the right boundary of the screen) of the screen. If the height of the bounding box is less than the width, it indicates that a longitudinal distance of motion of the target image is less than a transverse distance. In this case, the relative position information between the motion curve and the motion vector is determined through the distances between the bounding box and vertical boundaries (including the upper boundary and the lower boundary of the screen) of the screen.

Exemplarily, a manner for determining the relative position between the motion curve and the motion vector based on the first comparison result may be: if the first distance is greater than or equal to the second distance, determining that the motion curve is located on a side where the left edge is located; or if the first distance is less than the second distance, determining that the motion curve is located on a side where the right edge is located. A manner for determining the relative position between the motion curve and the motion vector based on the second comparison result may be: if the third distance is greater than or equal to the fourth distance, determining that the motion curve is located on a side where the upper edge is located; or if the third distance is less than the fourth distance, determining that the motion curve is located on a side where the lower edge is located.

If the first distance is greater than the second distance, it indicates that a larger space is provided on the side where the left edge of the bounding box is located. Therefore, the motion curve is set on the side where the left edge is located. Namely, the target image moves on the side where the left edge is located. If the first distance is less than the second distance, it indicates that a larger space is provided on the side where the right edge of the bounding box is located. Therefore, the motion curve is set on the side where the right edge is located. Namely, the target image moves on the side where the right edge is located. If the third distance is greater than the fourth distance, it indicates that a larger space is provided on the side where the upper edge of the bounding box is located. Therefore, the motion curve is set on the side where the upper edge is located. Namely, the target image moves on the side where the upper edge is located. If the third distance is less than the fourth distance, it indicates that a larger space is provided on the side where the lower edge of the bounding box is located. Therefore, the motion curve is set on the side where the lower edge is located. Namely, the target image moves on the side where the lower edge is located.

Exemplarily, FIG. 6 is a schematic diagram of determining the relative position information between the motion curve and the motion vector in this embodiment. As shown in FIG. 6, if the width w of the bounding box of motion vector AB is greater than the height h of the bounding box of motion vector AB, the third distance L3 between the upper edge of the bounding box and the upper boundary of the screen and the fourth distance L4 between the lower edge of the bounding box and the lower boundary of the screen are calculated. As illustrated in the figure, it can be seen that if L3 is greater than L4, the motion curve is set on the side where the upper edge is located, namely, the first side (the left side) of motion vector AB. In this embodiment, the motion curve is set on the side with a larger space, which can prevent the target image from being clipped by the screen in the moving process.

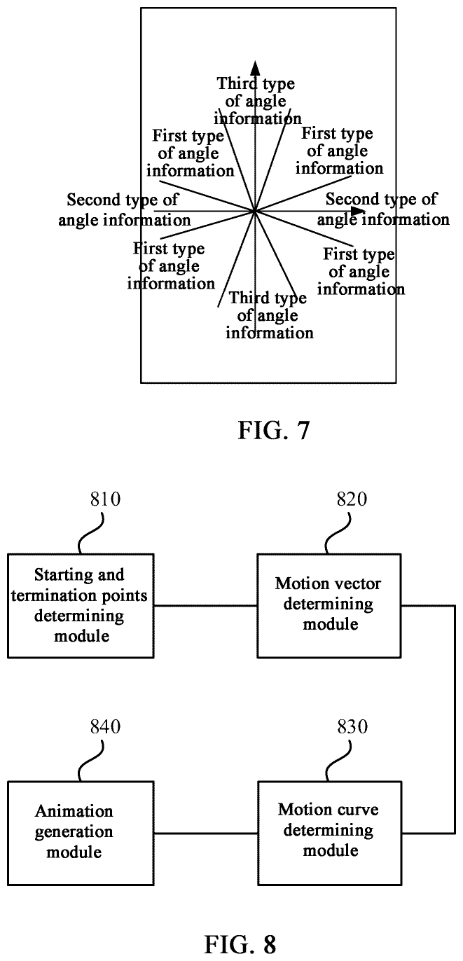

In this embodiment, the angle information includes any one of the following: the angle between the motion vector and the horizontal axis is greater than the set threshold and the angle between the motion vector and the vertical axis is greater than the set threshold, or the angle between the motion vector and the horizontal axis is less than the set threshold and the angle between the motion vector and the vertical axis is less than the set threshold. Exemplarily, FIG. 7 is an example diagram of the angle information of the motion vector in this embodiment. In FIG. 7, information indicating that the angle between the motion vector and the horizontal axis is greater than the set threshold and the angle between the motion vector and the vertical axis is greater than the set threshold is considered as a first type of angle information; information indicating that the angle between the motion vector and the horizontal axis is less than the set threshold is considered as a second type of angle information; and information indicating that the angle between the motion vector and the vertical axis is less than the set threshold is considered as a third type of angle information.

Optionally, a manner for determining the motion curve of the target image based on the direction information, the angle information, and the relative position information may be: if the angle information is the angle between the motion vector and the horizontal axis being greater than the set threshold and the angle between the motion vector and the vertical axis being greater than the set threshold, the direction information is the motion vector pointing to the first quadrant or the motion vector pointing to the third quadrant, and the motion curve is located on the first side of the motion vector, determining that the longitudinal motion curve is a first easing curve and the transverse motion curve is a set linear curve; if the angle information is the angle between the motion vector and the horizontal axis being greater than the set threshold and the angle between the motion vector and the vertical axis being greater than the set threshold, the direction information is the motion vector pointing to the second quadrant or the motion vector pointing to the fourth quadrant, and the motion curve is located on the first side of the motion vector, determining that the longitudinal motion curve is the second easing curve and the transverse motion curve is the set linear curve; if the angle information is the angle between the motion vector and the horizontal axis being greater than the set threshold and the angle between the motion vector and the vertical axis being greater than the set threshold, the direction information is the motion vector pointing to the second quadrant or the motion vector pointing to the fourth quadrant, and the motion curve is located on the first side of the motion vector, determining that the longitudinal motion curve is the second easing curve and the transverse motion curve is the set linear curve; or if the angle information is the angle between the motion vector and the horizontal axis being greater than the set threshold and the angle between the motion vector and the vertical axis being greater than the set threshold, the direction information is the motion vector pointing to the second quadrant or the motion vector pointing to the fourth quadrant, and the motion curve is located on the second side of the motion vector, determining that the longitudinal motion curve is the first easing curve and the transverse motion curve is the set linear curve.

The first easing curve may be an easing out transformation curve, and the second easing curve may be an easing in curve. Exemplarily, in a case that the angle information is the angle between the motion vector and the horizontal axis being greater than the set threshold and the angle between the motion vector and the vertical axis being greater than the set threshold, namely, when the angle information is the first type of angle information, if the motion vector points to the first quadrant or the third quadrant, and the motion curve is located on the first side (the left side) of the motion vector, the longitudinal motion curve uses the easing out transformation curve; if the motion vector points to the first quadrant or the third quadrant, and the motion curve is located on the second side (the right side) of the motion vector, the longitudinal motion curve uses the easing in transformation curve; if the motion vector points to the second quadrant or the fourth quadrant, and the motion curve is located on the first side (the left side) of the motion vector, the longitudinal motion curve uses the easing in transformation curve; or if the motion vector points to the second quadrant or the fourth quadrant, and the motion curve is located on the second side (the right side) of the motion vector, the longitudinal motion curve uses the easing out transformation curve. The transverse motion curves are all the set linear curves. In this embodiment, when the angle information is the angle between the motion vector and the horizontal axis being greater than the set threshold and the angle between the motion vector and the vertical axis being greater than the set threshold, the first easing curve or the second easing curve is determined as the longitudinal motion curve, so that the target image moves in an easing out manner or an easing in manner.

Optionally, the process of determining the motion curve of the target image based on the direction information, the angle information, and the relative position information may be: if the angle information is the angle between the motion vector and the horizontal axis being less than the set threshold, the direction information is the motion vector pointing to the first quadrant or the motion vector pointing to the third quadrant, and the motion curve is located on the first side of the motion vector, determining that the longitudinal motion curve is a third easing curve and the transverse motion curve is the set linear curve; if the angle information is the angle between the motion vector and the horizontal axis being less than the set threshold, the direction information is the motion vector pointing to the first quadrant or the motion vector pointing to the third quadrant, and the motion curve is located on the second side of the motion vector, determining that the longitudinal motion curve is a fourth easing curve and the transverse motion curve is the set linear curve; if the angle information is the angle between the motion vector and the horizontal axis being less than the set threshold, the direction information is the motion vector pointing to the second quadrant or the motion vector pointing to the fourth quadrant, and the motion curve is located on the first side of the motion vector, determining that the longitudinal motion curve is the fourth easing curve and the transverse motion curve is the set linear curve; or if the angle information is the angle between the motion vector and the horizontal axis being less than the set threshold, the direction information is the motion vector pointing to the second quadrant or the motion vector pointing to the fourth quadrant, and the motion curve is located on the second side of the motion vector, determining that the longitudinal motion curve is the third easing curve and the transverse motion curve is the set linear curve.

The third easing curve may be an easing back out transformation curve, and the fourth easing curve may be an easing back in transformation curve. Exemplarily, in a case that the angle information is the angle between the motion vector and the horizontal axis being less the set threshold, namely, when the angle information is the second type of angle information, if the motion vector points to the first quadrant or the third quadrant, and the motion curve is located on the first side (the left side) of the motion vector, then the longitudinal motion curve uses the easing back out transformation curve. If the motion vector points to the first quadrant or the third quadrant, and the motion curve is located on the second side (the right side) of the motion vector, then the longitudinal motion curve uses the easing back in transformation curve. If the motion vector points to the second quadrant or the fourth quadrant, and the motion curve is located on the first side (the left side) of the motion vector, then the longitudinal motion curve uses the easing back in transformation curve. If the motion vector points to the second quadrant or the fourth quadrant, and the motion curve is located on the second side (the right side) of the motion vector, then the longitudinal motion curve uses the easing back out transformation curve. The transverse motion curves are all the set linear curves. In this embodiment, when the angle information is the angle between the motion vector and the horizontal axis being less than the set threshold, the third easing curve or the fourth easing curve is determined as the longitudinal motion curve, so that the target image moves in an easing back out manner or an easing back in manner.

Optionally, the process of determining the longitudinal motion curve as the third easing curve or determining the longitudinal motion curve as the third easing curve may be: determining a target edge of the bounding box based on the direction information and the relative position information; determining a first coefficient or a second coefficient based on a distance between the target edge and a corresponding boundary of the screen and the size information of the bounding box; and generating the third easing curve based on the first coefficient, or generating the fourth easing curve based on the second coefficient.

The process of determining the target edge of the bounding box based on the direction information, the relative position information, and the size information of the bounding box may be: if the width of the bounding box is greater than the height of the bounding box, the direction information is pointing to the first quadrant or the fourth quadrant, and the relative position information is the motion curve being located on the first side of the motion vector, determining that the target edge is the upper edge; if the width of the bounding box is greater than the height, the direction information is pointing to the second quadrant or the third quadrant, and the relative position information is the motion curve being located on the first side of the motion vector, determining that the target edge is the lower edge; if the width of the bounding box is greater than the height, the direction information is pointing to the first quadrant or the second quadrant, and the relative position information is the motion curve being located on the second side of the motion vector, determining that the target edge is the left edge; if the width of the bounding box is greater than the height, the direction information is pointing to the third quadrant or the fourth quadrant, and the relative position information is the motion curve being located on the second side of the motion vector, determining that the target edge is the right edge; if the width of the bounding box is less than the height of the bounding box, the direction information is pointing to the first quadrant or the fourth quadrant, and the relative position information is the motion curve being located on the first side of the motion vector, determining that the target edge is the lower edge; if the width of the bounding box is less than the height, the direction information is pointing to the second quadrant or the third quadrant, and the relative position information is the motion curve being located on the first side of the motion vector, determining that the target edge is the upper edge; if the width of the bounding box is less than the height, the direction information is pointing to the first quadrant or the second quadrant, and the relative position information is the motion curve being located on the second side of the motion vector, determining that the target edge is the right edge; or if the width of the bounding box is less than the height, the direction information is pointing to the third quadrant or the fourth quadrant, and the relative position information is the motion curve being located on the second side of the motion vector, determining that the target edge is the left edge.

The target edge corresponds to a boundary of the screen, which may be understood as follows: The upper edge corresponds to the upper boundary of the screen; the lower edge corresponds to the lower boundary of the screen; the left edge corresponds to the left boundary of the screen; and the right edge corresponds to the right boundary of the screen.

Exemplarily, a manner for determining a first coefficient or a second coefficient based on a distance between the target edge and a corresponding boundary of the screen and the size information of the bounding box may be: when the target edge is the upper edge or the lower edge, if a set multiple of the distance between the upper edge and the upper boundary of the screen or a set multiple of the distance between the lower edge and the lower boundary of the screen is less than the height of the bounding box, determining a ratio of the set multiple of the distance between the upper edge and the upper boundary of the screen or the set multiple of the distance between the lower edge and the lower boundary of the screen to the height of the bounding box, and determining the first coefficient or the second coefficient based on the ratio; if the set multiple of the distance between the upper edge and the upper boundary of the screen or the set multiple of the distance between the lower edge and the lower boundary of the screen is greater than or equal to the height of the bounding box, determining the first coefficient or the second coefficient based on a first set value; when the target edge is the left edge or the right edge, if a set multiple of the distance between the left edge and the left boundary of the screen or a set multiple of the distance between the right edge and the right boundary of the screen is less than the height of the bounding box, determining a ratio of the set multiple of the distance between the left edge and the left boundary of the screen or the set multiple of the distance between the right edge and the right boundary of the screen to the height of the bounding box, and determining the first coefficient or the second coefficient based on the ratio; or if the set multiple of the distance between the left edge and the left boundary of the screen or the set multiple of the distance between the right edge and the right boundary of the screen is greater than or equal to the height of the bounding box, determining the first coefficient or the second coefficient based on the first set value.

The first set value is 1. A manner for determining the first coefficient or the second coefficient based on the ratio may be: inputting the ratio to a set fitting relationship to obtain the first coefficient or the second coefficient. A manner for determining the first coefficient or the second coefficient based on the first set value may be: inputting the first set value to a set fitting relationship to obtain the first coefficient or the second coefficient. For example, the ratio or the first set value is divided by 0.12 to obtain the first coefficient or the second coefficient. In this embodiment, the third easing curve is generated based on the first coefficient, or the fourth easing curve is generated based on the second coefficient, to ensure that the motion curve is within the screen, thereby preventing the target image from being clipped by the screen in the moving process.

Optionally, a manner for determining the motion curve of the target image based on the direction information, the angle information, and the relative position information may be: if the angle information is the angle between the motion vector and the vertical axis being less than the set threshold, the direction information is the motion vector pointing to the first quadrant or the motion vector pointing to the third quadrant, and the motion curve is located on the first side of the motion vector, determining that the transverse motion curve is a fifth easing curve and the longitudinal motion curve is the set linear curve; if the angle information is the angle between the motion vector and the vertical axis being less than the set threshold, the direction information is the motion vector pointing to the first quadrant or the motion vector pointing to the third quadrant, and the motion curve is located on the second side of the motion vector, determining that the transverse motion curve is a sixth easing curve and the longitudinal motion curve is the set linear curve; if the angle information is the angle between the motion vector and the vertical axis being less than the set threshold, the direction information is the motion vector pointing to the second quadrant or the motion vector pointing to the fourth quadrant, and the motion curve is located on the first side of the motion vector, determining that the transverse motion curve is the sixth easing curve and the longitudinal motion curve is the set linear curve; or if the angle information is the angle between the motion vector and the vertical axis being less than the set threshold, the direction information is the motion vector pointing to the second quadrant or the motion vector pointing to the fourth quadrant, and the motion curve is located on the second side of the motion vector, determining that the transverse motion curve is the fifth easing curve and the longitudinal motion curve is the set linear curve.

The fifth easing curve may be an easing back in transformation curve, and the sixth easing curve may be an easing back out transformation curve. Exemplarily, in a case that the angle information is the angle between the motion vector and the vertical axis being less the set threshold, namely, when the angle information is the third type of angle information, if the motion vector points to the first quadrant or the third quadrant, and the motion curve is located on the first side (the left side) of the motion vector, then the transverse motion curve uses the easing back in transformation curve. If the motion vector points to the first quadrant or the third quadrant, and the motion curve is located on the second side (the right side) of the motion vector, then the transverse motion curve uses the easing back out transformation curve. If the motion vector points to the second quadrant or the fourth quadrant, and the motion curve is located on the first side (the left side) of the motion vector, then the transverse motion curve uses the easing back out transformation curve. If the motion vector points to the second quadrant or the fourth quadrant, and the motion curve is located on the second side (the right side) of the motion vector, then the transverse motion curve uses the easing back in transformation curve. The longitudinal motion curves are all the set linear curves. In this embodiment, when the angle information is the angle between the motion vector and the vertical axis being less than the set threshold, the fifth easing curve or the sixth easing curve is determined as the transverse motion curve, so that the target image moves in an easing back in manner or an easing back out manner.

Optionally, the process of determining the transverse motion curve as the fifth easing curve or determining the transverse motion curve as the sixth easing curve may be: determining a target edge of the bounding box based on the direction information, the relative position information, and the size information of the bounding box; determining a third coefficient or a fourth coefficient based on a distance between the target edge and a corresponding boundary of the screen and the size information of the bounding box; and generating the fifth easing curve based on the third coefficient, or generating the sixth easing curve based on the fourth coefficient.

For the manner for determining the third coefficient and the fourth coefficient, refer to the process of determining the first coefficient and the second coefficient in the above embodiment. This will not be elaborated here. In this embodiment, the fifth easing curve is generated based on the third coefficient, or the sixth easing curve is generated based on the fourth coefficient, to ensure that the motion curve is within the screen, thereby preventing the target image from being clipped by the screen in the moving process.

S140. The target image is controlled to move from the starting point to the termination point according to the motion curve to generate a motion animation of the target image.

In this embodiment, the process of controlling the target image to move from the starting point to the termination point according to the motion curve can be understood as follows: First, position information of the target image at each time is determined according to the motion curve. Then, the target image is rendered to a position corresponding to the position information. The target images rendered at the various time form a motion animation.

Optionally, a manner for controlling the target image to move from the starting point to the termination point according to the motion curve to generate the motion animation of the target image may be: obtaining an animation progress corresponding to the current time; determining position information of the target image at the current time based on the animation progress and the motion curve; and rendering the target image to a current image based on the position information, to generate the motion animation of the target image.

The animation progress is a ratio of a duration between the current time and starting time to a total duration of the animation. Assuming that the duration between the current time and the starting time is t and the total duration of the animation is T, the animation progress is t/T. The process of determining the position information of the target image at the current time based on the animation progress and the motion curve may be: inputting the animation progress to the longitudinal motion curve to obtain a longitudinal coordinate at the current time, input the animation progress to the transverse motion curve to obtain a transverse coordinate at the current time, and forming the position information of the target image at the current time by the longitudinal coordinate and the transverse coordinate. In this embodiment, the position information of the target image at the current time is determined based on the animation progress and the motion curve, which can accurately render the target image to the corresponding position at each time, thereby ensuring that the target image moves according to the motion curve.

Optionally, after the animation progress corresponding to the current time is obtained, the method further includes the following step: performing easing processing on the animation progress. Correspondingly, a manner for determining the position information of the target image at the current time based on the animation progress and the motion curve may be: determining the position information of the target image at the current time based on the animation progress subjected to easing processing and the motion curve.

A manner for performing the easing processing on the animation progress may be: inputting the animation progress to a set easing curve to obtain the animation progress subjected to easing processing. In this embodiment, the easing processing is performed on the animation progress, which can improve the smoothness of the motion of the target image.

Optionally, the method further includes: controlling the target image to move, zoom in or out, or change the transparency in the moving process.

Exemplarily, a rotation direction and a target angle of the target image are determined based on the direction information, the angle information, and the relative position information; and the target image is controlled to rotate to the target angle from an initial angle along the rotation direction.

The rotation direction may include counterclockwise rotation or clockwise rotation. The target angle can be understood as a maximum angle of rotation of the target image. A manner for determining the rotation direction of the target image based on the direction information, the angle information, and the relative position information may be the following. In the following situations, the rotation direction is the counterclockwise rotation: the motion vector points to the first quadrant and the motion curve is located on the first side of the motion vector; the motion vector points to the second quadrant and the motion curve is located on the first side of the motion vector; the motion vector points to the third quadrant and the motion curve is located on the first side of the motion vector; and the motion vector points to the fourth quadrant and the motion curve is located on the second side of the motion vector. In the following situations, the rotation direction is the clockwise rotation: the motion vector points to the first quadrant and the motion curve is located on the second side of the motion vector; the motion vector points to the second quadrant and the motion curve is located on the second side of the motion vector; the motion vector points to the third quadrant and the motion curve is located on the second side of the motion vector; and the motion vector points to the fourth quadrant and the motion curve is located on the first side of the motion vector.

A manner for determining the target angle of the target image based on the direction information, the angle information, and the relative position information may be: if the motion vector points to the first quadrant and the motion curve is located on the first side of the motion vector, or if the motion vector points to the second quadrant and the motion curve is located on the second side of the motion vector, determining that the target angle is an angle between the motion vector and a positive direction of the vertical axis; if the motion vector points to the first quadrant and the motion curve is located on the second side of the motion vector, or if the motion vector points to the fourth quadrant and the motion curve is located on the first side of the motion vector, determining that the target angle is an angle between the motion vector and a positive direction of the horizontal axis; if the motion vector points to the third quadrant and the motion curve is located on the first side of the motion vector, or if the motion vector points to the fourth quadrant and the motion curve is located on the second side of the motion vector, determining that the target angle is an angle between the motion vector and a negative direction of the vertical axis; or if the motion vector points to the second quadrant and the motion curve is located on the first side of the motion vector, or if the motion vector points to the third quadrant and the motion curve is located on the second side of the motion vector, determining that the target angle is an angle between the motion vector and a negative direction of the horizontal axis. The target image is controlled to rotate to the target angle from an initial angle along the rotation direction, which can prevent the target image from rotating beyond the screen.

Optionally, the process of controlling the target image to rotate to the target angle from the initial angle along the rotation direction may be: obtaining a rotation easing curve; determining a rotation ratio of the current time based on the animation progress and the rotation easing curve; determining a current angle based on the rotation ratio and a rotation amplitude; and rendering the target image to a current image based on the current angle.

The rotation amplitude is a difference between the target angle and the initial angle. The rotation easing curve can be any easing curve rendered by a user, and will not be limited here. The animation progress can be an animation progress subjected to easing processing or an animation progress not subjected to easing processing. Exemplarily, the animation progress is input to the rotation easing curve to obtain the rotation ratio of the current time; and the rotation ratio is multiplied by the rotation amplitude to obtain the current angle, so that the target image is rendered to the current image based on the current angle. In this embodiment, the current angle is determined based on the rotation easing curve, which can improve the smoothness of the rotation of the target image.

Optionally, the method further includes the following steps: obtaining a scaling transformation curve and/or a transparency transformation curve; determining a scaling degree of the current time based on the animation progress and the scaling transformation curve, and/or determining transparency of the current time based on the animation progress and the transparency transformation curve; and rendering the target image to a current image based on the scaling degree and/or the transparency.

The scaling transformation curve and the transparency transformation curve may be linear curves or easing curves, which are not limited here. The animation progress can be an animation progress subjected to easing processing or an animation progress not subjected to easing processing. In this embodiment, the target image is rendered to the current image based on the scaling degree and/or the transparency, so that the target image presents a scaling and/or transparency transformation effect during motion, thereby improving the diversity of the animation.

According to the technical solutions of the embodiments of the present disclosure, a starting point and a termination point of a target image in a set coordinate system are determined; a motion vector of the target image is determined based on the starting point and the termination point, wherein the motion vector is a direction vector pointing from the starting point to the termination point; a motion curve of the target image is determined based on the motion vector, wherein the motion curve includes a transverse motion curve and a longitudinal motion curve; and the target image is controlled to move from the starting point to the termination point according to the motion curve to generate a motion animation of the target image. According to the image-based animation generation method provided in embodiments of the present disclosure, the target image is controlled to move from the starting point to the termination point according to the motion curve determined by the motion vector, so that the motion animation of the target image can be generated, making the generated motion animation smoothly transitioned and improving the fluency and display effect of the animation.

FIG. 8 is a schematic structural diagram of an image-based animation generation apparatus according to embodiments of the present disclosure. As shown in FIG. 8, the apparatus includes: a starting and termination points determining module 810, configured to determine a starting point and a termination point of a target image in a set coordinate system; a motion vector determining module 820, configured to determine a motion vector of the target image based on the starting point and the termination point, wherein the motion vector is a direction vector pointing from the starting point to the termination point; a motion curve determining module 830, configured to determine a motion curve of the target image based on the motion vector, wherein the motion curve includes a transverse motion curve and a longitudinal motion curve; and an animation generation module 840, configured to control the target image to move from the starting point to the termination point according to the motion curve to generate a motion animation of the target image.

Optionally, the motion curve determining module 830 is further configured to: obtain direction information, angle information with coordinate axes, and bounding box information of the motion vector, wherein a bounding box is a rectangular bounding box with each edge being parallel to a coordinate axis; and determine the motion curve of the target image based on the direction information, the angle information, and the bounding box information.

Optionally, the direction information includes any one of the following: the motion vector pointing to a first quadrant, the motion vector pointing to a second quadrant, the motion vector pointing to a third quadrant, or the motion vector pointing to a fourth quadrant. The angle information includes any one of the following: an angle between the motion vector and a horizontal axis being greater than a set threshold and an angle between the motion vector and a vertical axis being greater than the set threshold, or the angle between the motion vector and the horizontal axis being less than the set threshold and the angle between the motion vector and the vertical axis being less than the set threshold. The bounding box information includes size information of the bounding box and distances between edges of the bounding box and boundaries of a screen; where the size information includes a height and a width; and the edges of the bounding box include an upper edge, a lower edge, a left edge, and a right edge.

Optionally, the motion curve determining module 830 is further configured to: determine relative position information between the motion curve and the motion vector based on the bounding box information, wherein the relative position information includes the motion curve being located on a first side or a second side of the motion vector; and determine the motion curve of the target image based on the direction information, the angle information, and the relative position information.

Optionally, the motion curve determining module 830 is further configured to: if the height of the bounding box is greater than or equal to the width, obtain a first distance between the left edge of the bounding box and a left boundary of the screen and a second distance between the right edge of the bounding box and a right boundary of the screen; obtain a first comparison result between the first distance and the second distance, and determine the relative position information between the motion curve and the motion vector based on the first comparison result; if the height of the bounding box is less than the width, obtain a third distance between the upper edge of the bounding box and an upper boundary of the screen and a fourth distance between the lower edge of the bounding box and a lower boundary of the screen; and obtain a second comparison result between the third distance and the fourth distance, and determine the relative position information between the motion curve and the motion vector based on the second comparison result.

Optionally, the motion curve determining module 830 is further configured to: if the first distance is greater than or equal to the second distance, determine that the motion curve is located on a side where the left edge is located; or if the first distance is less than the second distance, determine that the motion curve is located on a side where the right edge is located.

The operation of determining relative position information between the motion curve and the motion vector based on the second comparison result includes: if the third distance is greater than or equal to the fourth distance, determining that the motion curve is located on a side where the upper edge is located; or if the third distance is less than the fourth distance, determining that the motion curve is located on a side where the lower edge is located.

Optionally, the motion curve determining module 830 is further configured to: if the angle information is the angle between the motion vector and the horizontal axis being greater than the set threshold and the angle between the motion vector and the vertical axis being greater than the set threshold, the direction information is the motion vector pointing to the first quadrant or the motion vector pointing to the third quadrant, and the motion curve is located on the first side of the motion vector, determine that the longitudinal motion curve is a first easing curve and the transverse motion curve is the set linear curve; if the angle information is the angle between the motion vector and the horizontal axis being greater than the set threshold and the angle between the motion vector and the vertical axis being greater than the set threshold, the direction information is the motion vector pointing to the first quadrant or the motion vector pointing to the third quadrant, and the motion curve is located on the second side of the motion vector, determine that the longitudinal motion curve is a second easing curve and the transverse motion curve is the set linear curve; if the angle information is the angle between the motion vector and the horizontal axis being greater than the set threshold and the angle between the motion vector and the vertical axis being greater than the set threshold, the direction information is the motion vector pointing to the second quadrant or the motion vector pointing to the fourth quadrant, and the motion curve is located on the first side of the motion vector, determine that the longitudinal motion curve is the second easing curve and the transverse motion curve is the set linear curve; or if the angle information is the angle between the motion vector and the horizontal axis being greater than the set threshold and the angle between the motion vector and the vertical axis being greater than the set threshold, the direction information is the motion vector pointing to the second quadrant or the motion vector pointing to the fourth quadrant, and the motion curve is located on the second side of the motion vector, determine that the longitudinal motion curve is the first easing curve and the transverse motion curve is the set linear curve.

Optionally, the motion curve determining module 830 is further configured to: if the angle information is the angle between the motion vector and the horizontal axis being less than the set threshold, the direction information is the motion vector pointing to the first quadrant or the motion vector pointing to the third quadrant, and the motion curve is located on the first side of the motion vector, determine that the longitudinal motion curve is a third easing curve and the transverse motion curve is the set linear curve; if the angle information is the angle between the motion vector and the horizontal axis being less than the set threshold, the direction information is the motion vector pointing to the first quadrant or the motion vector pointing to the third quadrant, and the motion curve is located on the second side of the motion vector, determine that the longitudinal motion curve is a fourth easing curve and the transverse motion curve is the set linear curve; if the angle information is the angle between the motion vector and the horizontal axis being less than the set threshold, the direction information is the motion vector pointing to the second quadrant or the motion vector pointing to the fourth quadrant, and the motion curve is located on the first side of the motion vector, determine that the longitudinal motion curve is the fourth easing curve and the transverse motion curve is the set linear curve; or if the angle information is the angle between the motion vector and the horizontal axis being less than the set threshold, the direction information is the motion vector pointing to the second quadrant or the motion vector pointing to the fourth quadrant, and the motion curve is located on the second side of the motion vector, determine that the longitudinal motion curve is the third easing curve and the transverse motion curve is the set linear curve.

Optionally, the motion curve determining module 830 is further configured to: determine a target edge of the bounding box based on the direction information, the relative position information, and the size information of the bounding box; determine a first coefficient or a second coefficient based on a distance between the target edge and a corresponding boundary of the screen and the size information of the bounding box; and generate the third easing curve based on the first coefficient, or generate the fourth easing curve based on the second coefficient.

Optionally, the motion curve determining module 830 is further configured to: if the angle information is the angle between the motion vector and the vertical axis being less than the set threshold, the direction information is the motion vector pointing to the first quadrant or the motion vector pointing to the third quadrant, and the motion curve is located on the first side of the motion vector, determine that the transverse motion curve is a fifth easing curve and the longitudinal motion curve is the set linear curve; if the angle information is the angle between the motion vector and the vertical axis being less than the set threshold, the direction information is the motion vector pointing to the first quadrant or the motion vector pointing to the third quadrant, and the motion curve is located on the second side of the motion vector, determine that the transverse motion curve is a sixth easing curve and the longitudinal motion curve is the set linear curve; if the angle information is the angle between the motion vector and the vertical axis being less than the set threshold, the direction information is the motion vector pointing to the second quadrant or the motion vector pointing to the fourth quadrant, and the motion curve is located on the first side of the motion vector, determine that the transverse motion curve is the sixth easing curve and the longitudinal motion curve is the set linear curve; or if the angle information is the angle between the motion vector and the vertical axis being less than the set threshold, the direction information is the motion vector pointing to the second quadrant or the motion vector pointing to the fourth quadrant, and the motion curve is located on the second side of the motion vector, determine that the transverse motion curve is the fifth easing curve and the longitudinal motion curve is the set linear curve.

Optionally, the motion curve determining module 830 is further configured to: determine a target edge of the bounding box based on the direction information, the relative position information, and the size information of the bounding box; determine a third coefficient or a fourth coefficient based on a distance between the target edge and a corresponding boundary of the screen and the size information of the bounding box; and generate the fifth easing curve based on the third coefficient, or generate the sixth easing curve based on the fourth coefficient.

Optionally, the animation generation module 840 is further configured to: obtain an animation progress corresponding to current time, wherein the animation progress is a ratio of a duration between the current time and starting time to a total duration of the animation; determine position information of the target image at the current time based on the animation progress and the motion curve; and render the target image to a current image based on the position information, to generate the motion animation of the target image.

Optionally, the animation generation module 840 is further configured to: perform easing processing on the animation progress; and determine the position information of the target image at the current time based on the animation progress subjected to easing processing and the motion curve.

Optionally, the apparatus further includes a rotation module, configured to: determine a rotation direction and a target angle of the target image based on the direction information, the angle information, and the relative position information; and control the target image to rotate to the target angle from an initial angle along the rotation direction.

Optionally, the rotation module is further configured to: obtain a rotation easing curve; determine a rotation ratio of the current time based on the animation progress and the rotation easing curve; determine a current angle based on the rotation ratio and a rotation amplitude, wherein the rotation amplitude is a difference between the target angle and the initial angle; and render the target image to a current image based on the current angle.

Optionally, the apparatus further includes a scaling or transparency transformation module, configured to: obtain a scaling transformation curve and/or a transparency transformation curve; determine a scaling degree of the current time based on the animation progress and the scaling transformation curve, and/or determine transparency of the current time based on the animation progress and the transparency transformation curve; and render the target image to a current image based on the scaling degree and/or the transparency.

The image-based animation generation apparatus provided by embodiments of the present disclosure can implement the image-based animation generation method provided by any embodiment of the present disclosure, and has corresponding functional modules for implementing the method.

It is worth noting that the various units and modules included in the above apparatus are only divided according to a functional logic, but are not limited to the above division, as long as the corresponding functions can be achieved. In addition, the specific names of the various functional units are only for the purpose of distinguishing and are not used to limit the protection scope of the embodiments of the present disclosure.

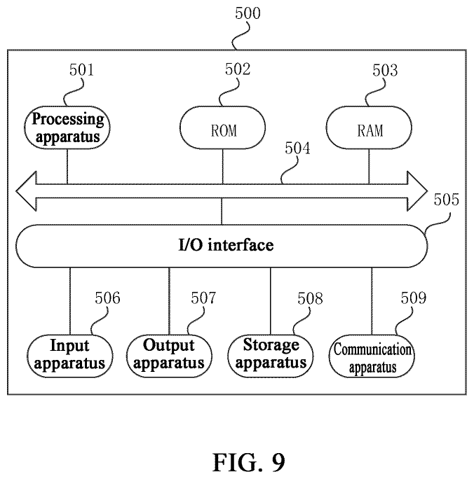

FIG. 9 is a schematic structural diagram of an electronic device according to the embodiments of the present disclosure. Reference is now made to FIG. 9 below, which illustrates a schematic structural diagram of an electronic device (namely, a terminal device or a server in FIG. 9) 500 suitable for implementing embodiments of the present disclosure. The terminal device in embodiments of the present disclosure may include but is not limited to a mobile terminal such as a mobile phone, a laptop, a digital broadcast receiver, a Personal Digital Assistant (PDA), a PAD, a Portable Media Player (PMP), an in-vehicle terminal (such as an in-vehicle navigation terminal), and a fixed terminal such as digital television (TV) and a desktop computer. The electronic device shown in FIG. 9 is only an example and should not impose any limitations on the functionality and scope of use of the embodiments of the present disclosure.

As shown in FIG. 9, the electronic device 500 may include a processing apparatus (such as a central processing unit and graphics processor) 501 that can perform various appropriate actions and processing according to programs stored in a Read-Only Memory (ROM) 502 or loaded from a storage apparatus 508 to a Random Access Memory (RAM) 503. Various programs and data required for operations of the electronic device 500 may also be stored in the RAM 503. The processing apparatus 501, the ROM 502, and the RAM 503 are connected to each other through a bus 504. An Input/Output (I/O) interface 505 is connected to the bus 504 too.

Usually, following apparatuses can be connected to the I/O interface 505: an input apparatus 506 including a touch screen, a touchpad, a keyboard, a mouse, a camera, a microphone, an accelerometer, a gyroscope, and the like; an output apparatus 507 including a Liquid Crystal Display (LCD), a speaker, a vibrator, and the like; a memory 508 including a magnetic tape, a hard disk drive, and the like; and a communication apparatus 509. The communication apparatus 509 can allow the electronic device 500 to wirelessly or wiredly communicate with other devices to exchange data. Although FIG. 9 shows the electronic device 500 with multiple apparatuses, it should be understood that the electronic device 500 is not required to implement or have all the apparatuses shown, and can alternatively implement or have more or fewer apparatuses.

Particularly, according to the embodiments of the present disclosure, the process described in the reference flowchart above can be implemented as a computer software program. For example, the embodiments of the present disclosure include a computer program product, including a computer program carried on a non-transitory computer-readable medium, and the computer program includes program codes used for performing the methods shown in the flowcharts. In such an embodiment, the computer program may be downloaded and installed from a network through the communication apparatus 509, or installed from the memory 508, or installed from the ROM 502. When the computer program is executed by the processing apparatus 501, the above-mentioned functions defined in the methods of the embodiments of the present disclosure are executed.

Messages or names of information interacted between a plurality of apparatuses in the implementations of the present disclosure are only for illustrative purposes and are not intended to limit the messages or the scope of the information.

The electronic device provided in embodiments of the present disclosure and the image-based animation generation method provided in the above embodiments belong to the same concept. Technical details not fully described in embodiments can be found in the above embodiments.

The embodiments of the present disclosure provide a computer storage medium having a computer program stored thereon. When run by a processor, the program implements the image-based animation generation method provided in the above embodiment.

It should be noted that the computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage media may include, but are not limited to: an electrical connection with one or more wires, a portable computer disk, a hard disk drive, a RAM, a ROM, an Erasable Programmable Read Only Memory (EPROM or flash memory), an optical fiber, Compact Disk Read Only Memory (CD-ROM), an optical storage device, a magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including but not limited to: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but not limited to: a wire, an optical cable, a Radio Frequency (RF), and the like, or any suitable combination of the above.

In some implementations, clients and servers can communicate using any currently known or future developed network protocol such as a HyperText Transfer Protocol (HTTP), and can intercommunicate and be interconnected with digital data in any form or medium (for example, a communication network). Examples of the communication network include a Local Area Network (LAN), a Wide Area Network (WAN), an internet (such as an Internet), a point-to-point network (such as an ad hoc point-to-point network, and any currently known or future developed network.

The computer-readable medium may be included in the electronic device or exist alone and is not assembled into the electronic device.

The above computer-readable medium carries at least one program. When the at least one program is run by the electronic device, the electronic device is caused to: determine a starting point and a termination point of a target image in a set coordinate system; determine a motion vector of the target image based on the starting point and the termination point, wherein the motion vector is a direction vector pointing from the starting point to the termination point; determine a motion curve of the target image based on the motion vector, wherein the motion curve includes a transverse motion curve and a longitudinal motion curve; and control the target image to move from the starting point to the termination point according to the motion curve to generate a motion animation of the target image.

Computer program codes for performing the operations of the present disclosure may be written in one or more programming languages or a combination thereof. The above programming languages include but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure can be implemented through software or hardware. The name of the unit does not constitute a limitation on the unit itself. For example, the first obtaining unit can also be described as “a unit that obtains at least two Internet protocol addresses”.

The functions described herein above may be performed, at least in part, by one or a plurality of hardware logic components. For example, nonrestrictively, example hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

The above description is only for explaining the optional embodiments of the present disclosure and technical principles used in the embodiments. Those skilled in the art should understand that the scope of disclosure referred to in the present disclosure is not limited to the technical solutions formed by specific combinations of the aforementioned technical features, but also covers other technical solutions formed by any combinations of the aforementioned technical features or their equivalent features without departing from the concept of the above disclosure, for example, a technical solution formed by replacing the above features with (but not limited to) technical features with similar functions disclosed in the present disclosure.

In addition, although various operations are depicted in a specific order, this should not be understood as requiring these operations to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. On the contrary, the specific features and actions described above are only exemplary forms for implementing the claims.

1. An image-based animation generation method, comprising:
determining a starting point and a termination point of a target image in a set coordinate system;
determining a motion vector of the target image based on the starting point and the termination point, wherein the motion vector is a direction vector pointing from the starting point to the termination point;
determining a motion curve of the target image based on the motion vector, wherein the motion curve comprises a transverse motion curve and a longitudinal motion curve; and
controlling the target image to move from the starting point to the termination point according to the motion curve to generate a motion animation of the target image.

2. The method of claim 1, wherein determining the motion curve of the target image based on the motion vector comprises:
obtaining direction information, angle information with coordinate axes, and bounding box information of the motion vector, wherein a bounding box is a rectangular bounding box that surrounds the motion vector and each edge of the rectangular bounding box is parallel to a coordinate axis; and
determining the motion curve of the target image based on the direction information, the angle information, and the bounding box information.

3. The method of claim 2, wherein, the direction information comprises any one of the motion vector pointing to a first quadrant, the motion vector pointing to a second quadrant, the motion vector pointing to a third quadrant, or the motion vector pointing to a fourth quadrant;
the angle information comprises any one of an angle between the motion vector and a horizontal axis being greater than a set threshold and an angle between the motion vector and a vertical axis being greater than the set threshold, or the angle between the motion vector and the horizontal axis being less than the set threshold and the angle between the motion vector and the vertical axis being less than the set threshold;
the bounding box information comprises size information of the bounding box and distances between edges of the bounding box and boundaries of a screen; wherein the size information comprises a height and a width, and the edges of the bounding box comprise an upper edge, a lower edge, a left edge, and a right edge.

4. The method of claim 3, wherein determining the motion curve of the target image based on the direction information, the angle information, and the bounding box information comprises:
determining relative position information between the motion curve and the motion vector based on the bounding box information, wherein the relative position information comprises the motion curve being located on a first side or a second side of the motion vector; and
determining the motion curve of the target image based on the direction information, the angle information, and the relative position information.

5. The method of claim 4, wherein determining the relative position information between the motion curve and the motion vector based on the bounding box information comprises:
in response to the height of the bounding box being greater than or equal to the width of the bounding box, obtaining a first distance between the left edge of the bounding box and a left boundary of the screen, and a second distance between the right edge of the bounding box and a right boundary of the screen;
obtaining a first comparison result between the first distance and the second distance, and determining the relative position information between the motion curve and the motion vector based on the first comparison result;
in response to the height of the bounding box being less than the width of the bounding box, obtaining a third distance between the upper edge of the bounding box and an upper boundary of the screen, and a fourth distance between the lower edge of the bounding box and a lower boundary of the screen; and
obtaining a second comparison result between the third distance and the fourth distance, and determining the relative position information between the motion curve and the motion vector based on the second comparison result.

6. The method of claim 5, wherein determining the relative position information between the motion curve and the motion vector based on the first comparison result comprises:
in response to the first distance being greater than or equal to the second distance, determining that the motion curve is located on a side where the left edge is located; and in response to the first distance being less than the second distance, determining that the motion curve is located on a side where the right edge is located; and
wherein determining the relative position information between the motion curve and the motion vector based on the second comparison result comprises:
in response to the third distance being greater than or equal to the fourth distance, determining that the motion curve is located on a side where the upper edge is located; and in response to the third distance being less than the fourth distance, determining that the motion curve is located on a side where the lower edge is located.

7. The method of claim 4, wherein determining the motion curve of the target image based on the direction information, the angle information, and the relative position information comprises:
in response to the angle information indicating that the angle between the motion vector and the horizontal axis is greater than the set threshold and the angle between the motion vector and the vertical axis is greater than the set threshold, the direction information indicating that the motion vector points to the first quadrant or the motion vector points to the third quadrant, and the motion curve being located on the first side of the motion vector, determining that the longitudinal motion curve is a first easing curve and the transverse motion curve is a set linear curve;
in response to the angle information indicating that the angle between the motion vector and the horizontal axis is greater than the set threshold and the angle between the motion vector and the vertical axis is greater than the set threshold, the direction information indicating that the motion vector points to the first quadrant or the motion vector points to the third quadrant, and the motion curve being located on the second side of the motion vector, determining that the longitudinal motion curve is a second easing curve and the transverse motion curve is the set linear curve;
in response to the angle information indicating that the angle between the motion vector and the horizontal axis is greater than the set threshold and the angle between the motion vector and the vertical axis is greater than the set threshold, the direction information indicating that the motion vector points to the second quadrant or the motion vector points to the fourth quadrant, and the motion curve being located on the first side of the motion vector, determining that the longitudinal motion curve is the second easing curve and the transverse motion curve is the set linear curve; and
in response to the angle information indicating that the angle between the motion vector and the horizontal axis is greater than the set threshold and the angle between the motion vector and the vertical axis is greater than the set threshold, the direction information indicating that the motion vector points to the second quadrant or the motion vector points to the fourth quadrant, and the motion curve being located on the second side of the motion vector, determining that the longitudinal motion curve is the first easing curve and the transverse motion curve is the set linear curve.

8. The method of claim 4, wherein determining the motion curve of the target image based on the direction information, the angle information, and the relative position information comprises:
in response to the angle information indicating that the angle between the motion vector and the horizontal axis is less than the set threshold, the direction information indicating that the motion vector points to the first quadrant or the motion vector points to the third quadrant, and the motion curve being located on the first side of the motion vector, determining that the longitudinal motion curve is a third easing curve and the transverse motion curve is a set linear curve;
in response to the angle information indicating that the angle between the motion vector and the horizontal axis is less than the set threshold, the direction information indicating that the motion vector points to the first quadrant or the motion vector points to the third quadrant, and the motion curve being located on the second side of the motion vector, determining that the longitudinal motion curve is a fourth easing curve and the transverse motion curve is the set linear curve;
in response to the angle information indicating that the angle between the motion vector and the horizontal axis is less than the set threshold, the direction information indicating that the motion vector points to the second quadrant or the motion vector points to the fourth quadrant, and the motion curve being located on the first side of the motion vector, determining that the longitudinal motion curve is the fourth easing curve and the transverse motion curve is the set linear curve; and
in response to the angle information indicating that the angle between the motion vector and the horizontal axis is less than the set threshold, the direction information indicating that the motion vector points to the second quadrant or the motion vector points to the fourth quadrant, and the motion curve being located on the second side of the motion vector, determining that the longitudinal motion curve is the third easing curve and the transverse motion curve is the set linear curve.

9. The method of claim 8, wherein determining that the longitudinal motion curve is the third easing curve or determining that the longitudinal motion curve is the fourth easing curve comprises:
determining a target edge of the bounding box based on the direction information, the relative position information, and the size information of the bounding box;
determining a first coefficient or a second coefficient based on a distance between the target edge and a corresponding boundary of the screen and the size information of the bounding box; and
generating the third easing curve based on the first coefficient, or generating the fourth easing curve based on the second coefficient.

10. The method of claim 4, wherein determining the motion curve of the target image based on the direction information, the angle information, and the relative position information comprises:
in response to the angle information indicating that the angle between the motion vector and the vertical axis is less than the set threshold, the direction information indicating that the motion vector points to the first quadrant or the motion vector points to the third quadrant, and the motion curve being located on the first side of the motion vector, determining that the transverse motion curve is a fifth easing curve and the longitudinal motion curve is a set linear curve;
in response to the angle information indicating that the angle between the motion vector and the vertical axis is less than the set threshold, the direction information indicating that the motion vector points to the first quadrant or the motion vector pointing to the third quadrant, and the motion curve being located on the second side of the motion vector, determining that the transverse motion curve is a sixth easing curve and the longitudinal motion curve is the set linear curve;
in response to the angle information indicating that the angle between the motion vector and the vertical axis is less than the set threshold, the direction information indicating that the motion vector points to the second quadrant or the motion vector pointing to the fourth quadrant, and the motion curve being located on the first side of the motion vector, determining that the transverse motion curve is the sixth easing curve and the longitudinal motion curve is the set linear curve; and
in response to the angle information indicating that the angle between the motion vector and the vertical axis is less than the set threshold, the direction information indicating that the motion vector points to the second quadrant or the motion vector pointing to the fourth quadrant, and the motion curve being located on the second side of the motion vector, determining that the transverse motion curve is the fifth easing curve and the longitudinal motion curve is the set linear curve.

11. The method of claim 10, wherein determining that the transverse motion curve is the fifth easing curve or determining that the transverse motion curve is the sixth easing curve comprises:
determining a target edge of the bounding box based on the direction information, the relative position information, and the size information of the bounding box;
determining a third coefficient or a fourth coefficient based on a distance between the target edge and a corresponding boundary of the screen and the size information of the bounding box; and
generating the fifth easing curve based on the third coefficient, or generating the sixth easing curve based on the fourth coefficient.

12. The method of claim 1, wherein controlling the target image to move from the starting point to the termination point according to the motion curve to generate the motion animation of the target image comprises:
obtaining an animation progress corresponding to a current time, wherein the animation progress is a ratio of a duration between the current time and a starting time to a total duration of the animation;
determining position information of the target image at the current time based on the animation progress and the motion curve; and
rendering the target image to a current image based on the position information, to generate the motion animation of the target image.

13. The method of claim 12, further comprising, after obtaining the animation progress corresponding to the current time,
performing easing processing on the animation progress; and
wherein determining the position information of the target image at the current time based on the animation progress and the motion curve comprises:
determining the position information of the target image at the current time based on the motion curve and the animation progress subjected to the easing processing.

14. The method of claim 4, further comprising:
determining a rotation direction and a target angle of the target image based on the direction information, the angle information, and the relative position information; and
controlling the target image to rotate to the target angle from an initial angle along the rotation direction.

15. The method of claim 14, wherein controlling the target image to rotate to the target angle from the initial angle along the rotation direction comprises:
obtaining a rotation easing curve;
determining a rotation ratio of a current time based on an animation progress and the rotation easing curve;
determining a current angle based on the rotation ratio of the current time and a rotation amplitude, wherein the rotation amplitude is a difference between the target angle and the initial angle; and
rendering the target image to a current image based on the current angle.

16. The method of claim 4, further comprising:
obtaining at least one of a scaling transformation curve or a transparency transformation curve;
performing at least one of determining a scaling degree of a current time based on an animation progress and the scaling transformation curve, or determining transparency of the current time based on the animation progress and the transparency transformation curve; and
rendering the target image to a current image based on at least one of the scaling degree of the current time or the transparency of the current time.

17. (canceled)

18. An electronic device, comprising:
at least one processor; and
a storage, configured to store at least one program,
wherein the at least one program, when executed by the at least one processor, causes the at least one processor to:
determine a starting point and a termination point of a target image in a set coordinate system;
determine a motion vector of the target image based on the starting point and the termination point, wherein the motion vector is a direction vector pointing from the starting point to the termination point;
determine a motion curve of the target image based on the motion vector, wherein the motion curve comprises a transverse motion curve and a longitudinal motion curve; and
control the target image to move from the starting point to the termination point according to the motion curve to generate a motion animation of the target image.

19. A non-transitory storage medium comprising computer-executable instructions, wherein when executed by a computer processor, the computer-executable instructions are used for implementing the image-based animation generation method comprising:
determining a starting point and a termination point of a target image in a set coordinate system;
determining a motion vector of the target image based on the starting point and the termination point, wherein the motion vector is a direction vector pointing from the starting point to the termination point;
determining a motion curve of the target image based on the motion vector, wherein the motion curve comprises a transverse motion curve and a longitudinal motion curve; and
controlling the target image to move from the starting point to the termination point according to the motion curve to generate a motion animation of the target image.

20. The electronic device of claim 18, wherein the at least one program, when executed by the at least one processor, causes the at least one processor to:
obtain direction information, angle information with coordinate axes, and bounding box information of the motion vector, wherein a bounding box is a rectangular bounding box that surrounds the motion vector and each edge of the rectangular bounding box is parallel to a coordinate axis; and
determine the motion curve of the target image based on the direction information, the angle information, and the bounding box information.

21. The electronic device of claim 18, wherein the at least one program, when executed by the at least one processor, causes the at least one processor to:
obtain an animation progress corresponding to a current time, wherein the animation progress is a ratio of a duration between the current time and a starting time to a total duration of the animation;
determine position information of the target image at the current time based on the animation progress and the motion curve; and
render the target image to a current image based on the position information, to generate the motion animation of the target image.
